(19) United States
(12) Patent Application Publication
(10) Pub. No.: US 2024/0010463 A1
(43) Pub. Date: Jan. 11, 2024

(54) ELEVATOR CONTROL SYSTEM, ELEVATOR SYSTEM AND METHOD FOR CONTROLLING ELEVATOR

(71) Applicant: Otis Elevator Company, Farmington, CT (US)

(72) Inventors: Yu Zhang, Shanghai (CN); Shenhong Wang, Shanghai (CN)

(21) Appl. No.: 18/070,848

(22) Filed: Nov. 29, 2022

(30) Foreign Application Priority Data
Jul. 5, 2022 (CN) 202210784137.5

(51) Int. Cl. B66B 1/46

(52) U.S. Cl. CPC B66B 1/468; B66B 2201/4653; B66B 2201/4676

(57) ABSTRACT

An elevator control system, an elevator system including the elevator control system, and a method for controlling an elevator. An elevator control system includes: one or more call-out units, each of which is provided at a corresponding elevator landing station; a control unit configured to perform the following operations: receiving a call request message from one or more of the call-out units, the call request message includes, in addition to an identification of a departure floor, at least one of: an identification of a call requester and a set of elevator resource demand features associated with the call requester; and generating a dispatching command for an elevator car in response to the received call request message.

### FOREIGN PRIORITY

This application claims priority to Chinese Patent Application No. 202210784137.5, filed Jul. 5, 2022, and all the benefits accruing therefrom under 35 U.S.C. § 119, the contents of which in its entirety are herein incorporated by reference.

### TECHNICAL FIELD

The present application relates to elevator technology, in particular to an elevator control system, an elevator system comprising the elevator control system, a method for controlling an elevator, and a computer-readable storage medium on which a computer program for implementing the method is stored.

### BACKGROUND

A typical elevator control system includes multiple call-out units and control units, in which the call-out units forward the user's call request messages to the control units, which respond to the call request messages and generate dispatching commands of the elevator car based on the current operating status of the elevator and the set dispatching logic.

As the level of urbanization increases, elevator application scenarios are increasingly rich. Therefore, a more intelligent elevator control trend is needed to adapt to this development trend to meet the needs of various applications.

### SUMMARY

According to an aspect of the present application, there is provided an elevator control system comprising: a plurality of call-out units, each of which is provided at a corresponding elevator landing station; a control unit configured to perform the following operations: receiving a call request message from one or more of the call-out units, wherein the call request message comprises, in addition to an identification of a departure floor, at least one of: an identification of a call requester and a set of elevator resource demand features associated with the call requester; and generating a dispatching command for an elevator car in response to the received call request message.

Optionally, in the above elevator control system, the call requester comprises a passenger and device, the call-out unit is configured to: receive a user identity identification or device identification from a mobile terminal or device via a wireless channel, and send to the control unit a floor identification corresponding to the call-out unit and the received user identity identification or device identification.

Optionally, in the above elevator control system, the set of elevator resource demand features comprises features in at least one of the following aspects: size of space occupied by the call requester, weight of the call requester, priority level of the call requester to take an elevator, restrictive requirements for the call requester to take the elevator with other call requesters, and restrictive requirements for the call requester to take the elevator alone.

Optionally, in the above elevator control system, the size of space occupied by the call requester is represented by discrete values, and each discrete value corresponds to a space range.

In addition to the one or more features described above, in the above elevator control system, the call request message comprises the identification of the departure floor and the identification of the call requester, the operation of generating the dispatching command for the elevator car is implemented in the following manner determining the set of elevator resource demand features corresponding to the identification of the call requester; determining, based on the determined set of elevator resource demand features, an elevator car matching the call request message; generating a dispatching command instructing the matched elevator car to travel to the departure floor.

In the above elevator control system, the control unit comprises local memory storing the set of elevator resource demand features of the call requester, and the control unit obtains the set of elevator resource demand features corresponding to the identification of the call requester by accessing the local memory.

In the above elevator control system, the set of elevator resource demand features of the call requester is stored in cloud, and the control unit obtains the set of elevator resource demand features corresponding to the identification of the call requester by accessing the cloud.

In the above elevator control system, the set of elevator resource demand features of the call requester is stored in the local memory of the control unit and in the cloud, and the control unit first obtains the set of elevator resource demand features corresponding to the identification of the call requester by accessing the local memory, and obtains the set of elevator resource demand features corresponding to the identification of the call requester by accessing the cloud when the obtaining fails.

In addition to the one or more features described above, in the above elevator control system, the call request message comprises the identification of the departure floor and the set of elevator resource demand features, the operation of generating the dispatching command for the elevator car is implemented in the following manner determining an elevator car matching the call request message based on the set of elevator resource demand features in the call request message; generating a dispatching command instructing the matched elevator car to travel to the departure floor.

In the above elevator control system, the call-out unit is configured to perform the following operations: obtaining an image near a panel of the call-out unit when the call-out unit receives a user input; extracting a profile of a moving object in the obtained image; determining, based on the extracted profile, a set of elevator resource demand features associated with the call requester.

In addition to the one or more features described above, in the above elevator control system, the call request message comprises the identification of the departure floor, the identification of the call requester and the set of elevator resource demand features, the control unit is further configured to perform at least one of the following operations: storing the set of elevator resource demand features corresponding to the identification of the call requester in the local memory of the control unit; uploading the set of elevator resource demand features corresponding to the identification of the call requester to the cloud.

According to another aspect of the present application, there is provided an elevator system comprising the elevator control system having one or more features as described above.

According to another aspect of the present application, there is provided a method for controlling an elevator comprising: A. generating a call request message by one or more of a plurality of call-out units, wherein each call-out unit is provided at a corresponding elevator landing station, the call request message comprises, in addition to an identification of a departure floor, at least one of: an identification of a call requester and a set of elevator resource demand features associated with the call requester; and B. generating, by a control unit, a dispatching command for an elevator car in response to the call request message.

According to a further aspect of the present application, there is provided a computer-readable storage medium on which a computer program suitable for running on a processor of a terminal device is stored, the running of the computer program causes steps of the method as described above to be performed.

### DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1 is a schematic block diagram of a typical elevator system.

FIG. 2 is a schematic block diagram of a typical elevator controller.

FIG. 3 is a flowchart of a method for controlling an elevator in accordance with some embodiments of the present application.

FIG. 4 is a flowchart of a method for generating a dispatching command for an elevator car in accordance with some other embodiments of the present application.

FIG. 5 is a flowchart of a method for controlling an elevator in accordance with some other embodiments of the present application.

FIG. 6 is a flowchart of a method for obtaining a set of elevator resource demand features in accordance with some other embodiments of the present application.

FIG. 7 is a flowchart of a method for generating a dispatching command for an elevator car in accordance with some other embodiments of the present application.

FIG. 8 is a flowchart of a method for controlling an elevator in accordance with some other embodiments of the present application.

### DETAILED DESCRIPTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

According to an aspect of the application, a call request message provided by the call-out units contains “multi-dimensional” information. In particular, the call request message comprises, in addition to information such as a departure floor, at least one of: an identification of a call requester and a set of elevator resource demand features associated with the call requester. The introduction of multiple types of information can better characterize the call demand features, so as to meet the application requirements in multiple scenarios.

In some embodiments, the set of elevator resource demand features may include features about size of space occupied by the call requester. It should be pointed out that the call requester includes not only passengers, but also various devices. Examples of such devices include a device with self-propelled capabilities (e.g., sweeping robots, disinfection robots, automated delivery vehicles, etc.) and device requiring human propulsion (e.g., wheelchairs and trolleys, etc.).

In other embodiments, the set of elevator resource demand features may include other demand features in addition to the size of space occupied, such as, but not limited to, weight of the call requester (which is useful to prevent overloading of an elevator), priority level of the call requester to take an elevator (e.g., when it is necessary to give priority for the assignment of elevator to specific passengers (e.g., VIP customers) or device (e.g., wheelchairs)), restrictive requirements for the call requester to take the elevator with other call requesters (e.g., when the disinfection robot and passengers cannot share the elevator for safety reasons), and restrictive requirements for the call requester to take the elevator alone (e.g., when children are prohibited from taking the elevator alone for safety reasons).

Optionally, in the above embodiments, the size of space occupied by the call requester may be represented by discrete values, where each discrete value corresponds to a space range. Exemplarily, the space occupied by the passenger may be divided into a number of ranges, the smallest range corresponds to the size of space normally occupied by a child, the middle range corresponds to the size of space normally occupied by an adult female, and the largest range corresponds to the size of space normally occupied by an adult male. A similar division and discretization can be made for the size of space occupied by the device.

According to another aspect of the application, a call request message provided by the call-out units contains an identification of a departure floor and an identification of a call requester. In some embodiments, the identification of the call requester may be a user identity identification or a device identification. Optionally, the call-out unit may receive the user identity identification or device identification from the passenger's mobile terminal or device via a wireless channel and send to a control unit a floor identification corresponding to the call-out unit and the received user identity identification or device identification. Accordingly, the control unit may determine a corresponding set of elevator resource demand features from the identification of the call requester, determine an elevator car matching the call request message based on the determined set of elevator resource demand features and generate a dispatching command instructing the matched elevator car to travel to the departure floor.

Exemplarily, the set of elevator resource demand features of the call requester may be stored in local memory of the control unit such that the control unit may determine the corresponding set of elevator resource demand features by accessing the local memory. In additional examples, the set of elevator resource demand features of the call requester may also be stored in the cloud, such that the control unit may determine the corresponding set of elevator resource demand features by accessing the cloud. In still other examples, the set of elevator resource demand features of the call requester may be stored in the local memory of the control unit and in the cloud, and the control unit first accesses the local memory to obtain the corresponding set of elevator resource demand features, and if that fails, then accesses the cloud to determine the corresponding set of elevator resource demand features. By storing the set of elevator resource demand features in the cloud, it enables a large number of elevator systems distributed within a geographical area (e.g., a city, state, or region) to share the elevator resource demand features of the call requester. On the other hand, by accessing the local memory first and accessing the cloud when the obtaining fails, the obtaining speed of the set of elevator resource demand features can be accelerated and the congestion of remote access can be avoided.

According to a further aspect of the application, a call request message provided by the call-out units contains the identification of the departure floor and the set of elevator resource demand features. In some embodiments, the call-out unit determines the set of elevator resource demand features in the following manner obtaining an image near a panel of the call-out unit when the call-out unit receives a user input (e.g., the user presses or touches a button on the panel of the call-out unit). Optionally, to determine a moving object in the image, the obtained image may comprise a series of image frames.

Subsequently, the call-out unit extracts a profile of the moving object in the obtained image. Typically, the user is in a moving state in the elevator landing station area before entering his or her instructions to take the elevator, so it is a probable event that the moving object in the image belongs to the call requester. Identifying the moving object as the call requester can significantly reduce the complexity of the processing algorithm without sacrificing the accuracy of the processing results substantially.

Next, the call-out unit may determine the set of elevator resource demand features associated with the call requester based on the extracted profile.

According to a further aspect of the application, a call request message provided by the call-out units contains the identification of the departure floor, the identification of the call requester, and the set of elevator resource demand features. In some embodiments, after receiving the call request message, the control unit, in addition to determining the elevator car matching the call request message based on a trigger floor and the set of elevator resource demand features and generating a corresponding dispatching command, stores in the local memory the set of elevator resource demand features corresponding to the call requester. In some other embodiments, the control unit also uploads the set of elevator resource demand features corresponding to the call requester to the cloud for sharing with other elevator systems. For one call requester, it may use the services of multiple elevator systems. Therefore, by sharing in the cloud, multiple data sources can be used to improve the data quality of the set of elevator resource demand features.

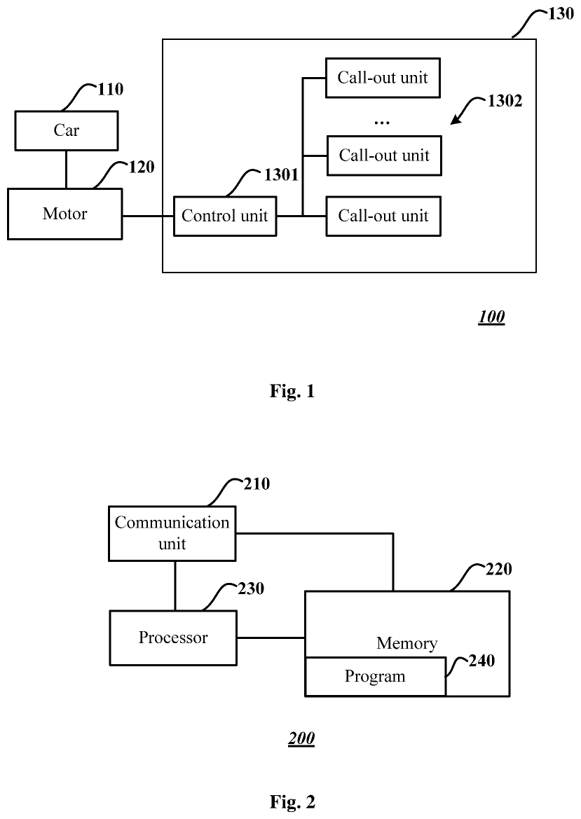

FIG. 1 is a schematic block diagram of a typical elevator system.

An elevator system 100 shown in FIG. 1 includes a car 110, a motor 120 for driving the movement of the car 110, and an elevator control system 130, wherein the elevator control system 130 includes a control unit 1301 and call-out units 1302 deployed on a plurality of floors.

The control unit 1301 generates corresponding control commands based on the call request messages received from one or more of the plurality of call-out units 1302, and the motor 120 controls the movement of the car 110 based on the generated control commands.

FIG. 2 is a schematic block diagram of a typical elevator controller. The control unit shown in FIG. 2 can be used to implement the control unit in FIG. 1.

As shown in FIG. 2, an elevator controller 200 contains a communication unit 210, a memory 220 (e.g., non-volatile memory such as flash memory, ROM, hard disk drive, magnetic disk, optical disc), a processor 230, and a computer program 240.

The communication unit 210 serves as a communication interface and is configured to establish a communication connection between the elevator controller and an external device (e.g., the call-out unit) or a network (e.g., the Internet).

The memory 220 stores the computer program 240 that can be executed by the processor 230. In addition, the memory 220 may store the set of elevator resource demand features of the call requester.

The processor 230 is configured to run the computer program 240 stored on the memory 220 and to access data (e.g., query, add, and modify the set of elevator resource demand features, etc.) on the memory 220.

The computer program 240 may include computer instructions for implementing the method for controlling the elevator described below with the help of the accompanying drawings, such that the corresponding methods can be implemented when the computer program 240 is run on the processor 230.

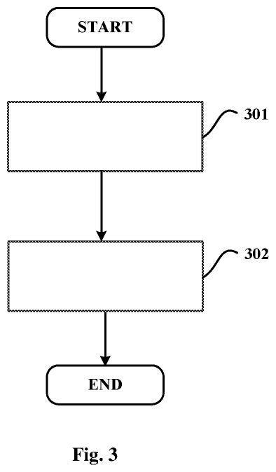

FIG. 3 is a flowchart of a method for controlling an elevator in accordance with some embodiments of the present application. Exemplarily, the method described below is implemented with the help of the elevator control system shown in FIGS. 1 and 2.

The method for controlling an elevator shown in FIG. 3 begins at step 301. In this step, one or more of the plurality of call-out units 1302 generate a call request message. In this embodiment, each call request message includes an identification ID_FLOOR of the floor on which the call-out unit is located (i.e., an identification of the departure floor of the call requester) and an identification ID_REQUESTER of the call requester.

In some embodiments, the identification ID_REQUESTER of the call requester may be a user identity identification (e.g., when the call requester is a passenger) or a device identification (e.g., when the call requester is a device). Usually, wireless communication function is a standard configuration function of the device and the mobile terminal of the user, so in this step, the call-out unit may receive the user identity identification or the device identification from the mobile terminal of the passenger or the device via the wireless channel, and include the floor identification corresponding to the call-out unit and the received user identity identification or device identification in the call request message sent to the control unit or elevator controller 1301.

The method shown in FIG. 3 then proceeds to step 302. In this step, the elevator controller 1301 generates a dispatching command for the elevator car in response to one or more call request messages.

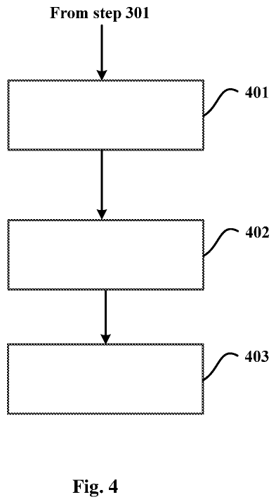

Step 302 may be implemented using the method illustrated in FIG. 4. Specifically, the method illustrated in FIG. 4 includes the following steps:

Step 401: the elevator controller 1301 obtains the set of elevator resource demand features corresponding to the identification of the call requester.

In this step, a variety of ways can be used to obtain the corresponding set of elevator resource demand features. For example, in one of the implementations, the set of elevator resource demand features of the call requester is stored in the local memory of the elevator controller 1301, and the elevator controller 1301 may obtain the set of elevator resource demand features corresponding to the identification of the call requester by accessing the local memory. In another implementation, the set of elevator resource demand features of the call requester is stored in the cloud, and the elevator controller 1301 may obtain the set of elevator resource demand features corresponding to the identification of the call requester by accessing the cloud. In yet another implementation, the set of elevator resource demand features of the call requester is stored in the local memory and the cloud, and the elevator controller 1301 first accesses the local memory to obtain the set of elevator resource demand features corresponding to the identification of the call requester, and then accesses the cloud to obtain the corresponding set of elevator resource demand features when the obtaining fails.

Step 402: the elevator controller 1301 determines the elevator cars matching the respective call request messages based on the set of elevator resource demand features obtained in step 401. In this step, a variety of elevator scheduling algorithms can be used to determine the matching elevator cars for the call request messages for various application scenarios.

Exemplarily, when the set of elevator resource demand features contains features about size of space occupied by the call requester, the elevator cars can be dispatched for the elevator requester based on the principle of resource utilization efficiency priority. For example, the set of elevator resource demand features may contain one or more of the following features in addition to the feature of occupied space: weight of the call requester, priority level of the call requester to take an elevator, restrictive requirements for the call requester to take the elevator with other call requesters, and restrictive requirements for the call requester to take the elevator alone. When the set of elevator resource demand features contains multiple features, a complex elevator scheduling algorithm will be used to complete the allocation of elevator cars.

Step 403: the elevator controller 1301 generates a dispatching command instructing the matched elevator car to travel to the departure floor.

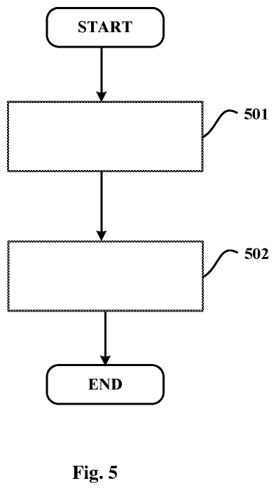

FIG. 5 is a flowchart of a method for controlling an elevator in accordance with some other embodiments of the present application. Exemplarily, the method described below is also implemented with the help of the elevator control system shown in FIGS. 1 and 2.

The method for controlling an elevator shown in FIG. 5 begins at step 501. In this step, one or more of the plurality of call-out units 1302 generate a call request message. In this embodiment, each call request message includes an identification ID_FLOOR of the floor on which the call-out unit is located and a set of elevator resource demand features Ω.

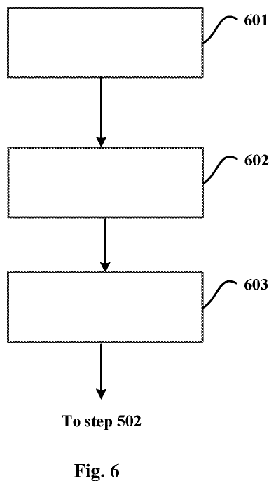

In this embodiment, the set of elevator resource demand features SI may be obtained in the manner shown in FIG. 6. Specifically, the method shown in FIG. 6 includes the following steps:

Step 601: when the call-out units 1302 receive a user input (e.g., when the user presses or touches a button on the panel of the call-out unit), an image near the panel of the call-out unit is obtained. As described above, the obtained image may comprise a series of image frames.

Step 602: the call-out units 1302 extract a profile of the moving object in the obtained image.

Step 603: the call-out units 1302 may determine the set of elevator resource demand features Ω associated with the call requester based on the extracted profile.

The method shown in FIG. 5 then moves to step 502. In this step, the elevator controller 1301 generates a dispatching command for the elevator car in response to one or more call request messages.

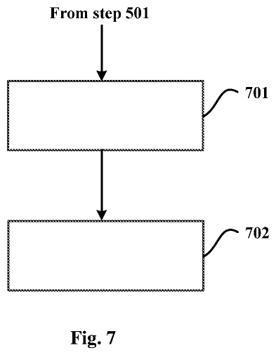

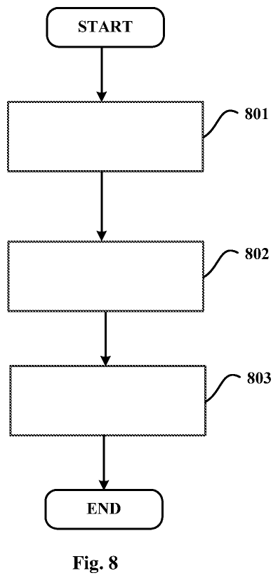

Step 502 may be implemented using the method illustrated in FIG. 7. Specifically, the method illustrated in FIG. 7 includes the following steps:

Step 701: the elevator controller 1301 determines the elevator cars matching the respective call request messages based on the set of elevator resource demand features Ω in the call request messages. Similarly, a variety of elevator scheduling algorithms can be used to determine the matching elevator cars for the call request messages for various application scenarios.

Step 702: the elevator controller 1301 generates a dispatching command instructing the matched elevator car to travel to the departure floor.

FIG. 8 is a flowchart of a method for controlling an elevator in accordance with some other embodiments of the present application. Exemplarily, the method described below is also implemented with the help of the elevator control system shown in FIGS. 1 and 2.

The method for controlling an elevator shown in FIG. 8 begins at step 801. In this step, one or more of the plurality of call-out units 1302 generate a call request message. In this embodiment, each call request message includes an identification ID_FLOOR of the floor on which the call-out unit is located, an identification ID_REQUESTER of the call requester and a set of elevator resource demand features SI.

In this step, the identification of the call requester may be the user identity identification or device identification received by the call-out unit via the wireless channel, and the set of elevator resource demand features Ω may be obtained in the manner shown in FIG. 6.

The method shown in FIG. 8 then proceeds to step 802. In this step, the elevator controller 1301 generates a dispatching command for the elevator car in response to one or more call request messages. Step 802 may be implemented using the method shown in FIG. 7.

Then proceeding to step 803, the elevator controller 1301 performs at least one of the following operations: a) Storing the set of elevator resource demand features corresponding to the identification of the call requester in the local memory of the elevator controller; b) Uploads the set of elevator resource demand features corresponding to the identification of the call requester to the cloud.

According to another aspect of the present application, there is also provided a computer-readable storage medium on which a computer program is stored. When the program is executed by the processor, one or more steps contained in the methods described above with the help of FIGS. 3-8 may be realized.

The computer-readable storage medium referred in the application includes various types of computer storage medium, and may be any available medium that may be accessed by a general-purpose or special-purpose computer. For example, the computer-readable storage medium may include RAM, ROM, EPROM, E2PROM, registers, hard disks, removable disks, CD-ROM or other optical disk storage, magnetic disk storage or other magnetic storage device, or any other transitory or non-transitory medium that may be used to carry or store a desired program code unit in the form of instructions or data structures and that may be accessed by a general-purpose or special-purpose computer or a general-purpose or special-purpose processor. The above combination should also be included in the protection scope of the computer-readable storage medium. An exemplary storage medium is coupled to the processor such that the processor can read and write information from and to the storage medium. In the alternative, the storage medium may be integrated into the processor. The processor and the storage medium may reside in the ASIC. The ASIC may reside in the user terminal. In the alternative, the processor and the storage medium may reside as discrete components in the user terminal.

Those skilled in the art will appreciate that the various illustrative logical blocks, modules, circuits, and algorithm steps described herein may be implemented as electronic hardware, computer software, or combinations of both.

To demonstrate this interchangeability between hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. An elevator control system, comprising:
a plurality of call-out units, each of which is provided at a corresponding elevator landing station;
a control unit configured to perform the following operations:
receiving a call request message from one or more of the call-out units, wherein the call request message comprises, in addition to an identification of a departure floor, at least one of: an identification of a call requester and a set of elevator resource demand features associated with the call requester; and
generating a dispatching command for an elevator car in response to the received call request message.

2. The elevator control system of claim 1, wherein the call requester comprises a passenger and device, the call-out unit is configured to: receive a user identity identification or device identification from a mobile terminal or device via a wireless channel, and send to the control unit a floor identification corresponding to the call-out unit and the received user identity identification or device identification.

3. The elevator control system of claim 1, wherein the set of elevator resource demand features comprises features in at least one of the following aspects: size of space occupied by the call requester, weight of the call requester, priority level of the call requester to take an elevator, restrictive requirements for the call requester to take the elevator with other call requesters, and restrictive requirements for the call requester to take the elevator alone.

4. The elevator control system of claim 3, wherein the size of space occupied by the call requester is represented by discrete values, and each discrete value corresponds to a space range.

5. The elevator control system of claim 1, wherein the call request message comprises the identification of the departure floor and the identification of the call requester, the operation of generating the dispatching command for the elevator car is implemented in the following manner:
determining the set of elevator resource demand features corresponding to the identification of the call requester;
determining, based on the determined set of elevator resource demand features, an elevator car matching the call request message;
generating a dispatching command instructing the matched elevator car to travel to the departure floor.

6. The elevator control system of claim 5, wherein the control unit comprises local memory storing the set of elevator resource demand features of the call requester, and the control unit obtains the set of elevator resource demand features corresponding to the identification of the call requester by accessing the local memory.

7. The elevator control system of claim 5, wherein the set of elevator resource demand features of the call requester is stored in cloud, and the control unit obtains the set of elevator resource demand features corresponding to the identification of the call requester by accessing the cloud.

8. The elevator control system of claim 5, wherein the set of elevator resource demand features of the call requester is stored in local memory of the control unit and in cloud, and the control unit first obtains the set of elevator resource demand features corresponding to the identification of the call requester by accessing the local memory, and obtains the set of elevator resource demand features corresponding to the identification of the call requester by accessing the cloud when the obtaining fails.

9. The elevator control system of claim 3, wherein the call request message comprises the identification of the departure floor and the set of elevator resource demand features, the operation of generating the dispatching command for the elevator car is implemented in the following manner:
determining an elevator car matching the call request message based on the set of elevator resource demand features in the call request message;
generating a dispatching command instructing the matched elevator car to travel to the departure floor.

10. The elevator control system of claim 9, wherein the call-out unit is configured to perform the following operations:
obtaining an image near a panel of the call-out unit when the call-out unit receives a user input;
extracting a profile of a moving object in the obtained image;
determining, based on the extracted profile, a set of elevator resource demand features associated with the call requester.

11. The elevator control system of claim 1, wherein the call request message comprises the identification of the departure floor, the identification of the call requester and the set of elevator resource demand features, the control unit is further configured to perform at least one of the following operations:
storing the set of elevator resource demand features corresponding to the identification of the call requester in local memory of the control unit;
uploading the set of elevator resource demand features corresponding to the identification of the call requester to cloud.

12. An elevator system comprising the elevator control system of claim 1.

13. A method for controlling an elevator, comprising:
A. generating a call request message by one or more of a plurality of call-out units, wherein each call-out unit is provided at a corresponding elevator landing station, the call request message comprises, in addition to an identification of a departure floor, at least one of: an identification of a call requester and a set of elevator resource demand features associated with the call requester; and
B. generating, by a control unit, a dispatching command for an elevator car in response to the call request message.

14. The method of claim 13, wherein the call requester comprises a passenger and device, step A comprises:
receiving a user identity identification or device identification from a mobile terminal or device via a wireless channel;
sending to the control unit a floor identification corresponding to the call-out unit and the received user identity identification or device identification.

15. The method of claim 13, wherein the set of elevator resource demand features comprises features in at least one of the following aspects: size of space occupied by the call requester, weight of the call requester, priority level of the call requester to take an elevator, restrictive requirements for the call requester to take the elevator with other call requesters, and restrictive requirements for the call requester to take the elevator alone.

16. The method of claim 15, wherein the size of space occupied by the call requester is represented by discrete values, and each discrete value corresponds to a space range.

17. The method of claim 13, wherein the call request message comprises the identification of the departure floor and the identification of the call requester, step B comprises:
determining the set of elevator resource demand features corresponding to the identification of the call requester;
determining, based on the determined set of elevator resource demand features, an elevator car matching the call request message;
generating a dispatching command instructing the matched elevator car to travel to the departure floor.

18. The method of claim 17, wherein the control unit comprises local memory storing the set of elevator resource demand features of the call requester, and the control unit obtains the set of elevator resource demand features corresponding to the identification of the call requester by accessing the local memory.

19. The method of claim 17, wherein the set of elevator resource demand features of the call requester is stored in cloud, and the control unit obtains the set of elevator resource demand features corresponding to the identification of the call requester by accessing the cloud.

20. The method of claim 17, wherein the set of elevator resource demand features of the call requester is stored in local memory of the control unit and in cloud, and the control unit first obtains the set of elevator resource demand features corresponding to the identification of the call requester by accessing the local memory, and obtains the set of elevator resource demand features corresponding to the identification of the call requester by accessing the cloud when the obtaining fails.

21. The method of claim 15, wherein the call request message comprises the identification of the departure floor and the set of elevator resource demand features, step B comprises:
determining an elevator car matching the call request message based on the set of elevator resource demand features in the call request message;
generating a dispatching command instructing the matched elevator car to travel to the departure floor.

22. The method of claim 21, wherein step A comprises:
obtaining an image near a panel of the call-out unit when the call-out unit receives a user input;
extracting a profile of a moving object in the obtained image;
determining, based on the extracted profile, a set of elevator resource demand features associated with the call requester.

23. The method of claim 13, wherein the call request message comprises the identification of the departure floor, the identification of the call requester and the set of elevator resource demand features, the method further comprises at least one of the following steps:
storing the set of elevator resource demand features corresponding to the identification of the call requester in local memory of the control unit;
uploading the set of elevator resource demand features corresponding to the identification of the call requester to cloud.

24. A computer-readable storage medium having instructions stored in the computer-readable storage medium, when the instructions are executed by a processor, the processor is caused to execute the method of claim 13.
